(19) United States
(12) Patent Application Publication
(10) Pub. No.: US 2020/0359627 A1
(43) Pub. Date: Nov. 19, 2020

(54) Flumioxazin Compositions

(71) Applicant: Nufarm Americas, Inc., Aslip, IL (US)

(72) Inventors: Thomas BYRNE, Morrisville, NC (US); Robert BRUSS, Morrisville, NC (US); Brian PIKE, Morrisville, NC (US); Jerome KOVAR, Morrisville, NC (US)

(21) Appl. No.: 16/944,800

(22) Filed: Jul. 31, 2020

Related U.S. Application Data
(63) Continuation of application No. 15/775,101, filed on May 10, 2018.
(60) Provisional application No. 62/253,477, filed on Nov. 10, 2015.

(51) Int. Cl. A01N 43/84; A01N 25/04; A01N 39/04; A01N 43/707; A01N 43/50

(52) U.S. Cl. CPC A01N 43/84; A01N 25/04; A01N 43/50; A01N 43/707; A01N 39/04

(57) ABSTRACT

An aqueous liquid herbicide composition comprising a water-insoluble pesticide, for example flumioxazin, and one or more water-soluble pesticides, for example one or more of dicamba, 2,4-D, metribuzin, and imazethapyr, is provided. The water-soluble pesticide is dissolved in a continuous aqueous phase of the composition and solid particles of the water-insoluble pesticide are suspended in the aqueous phase. These compositions exhibit enhanced resistance to settling of the solid particles and/or enhanced resistance to chemical degradation of the water-insoluble pesticide by comparison with otherwise similar compositions.

### TECHNICAL FIELD

The invention relates to suspension concentrate flumioxazin compositions and methods for using the formulations in controlling weeds in crops.

### BACKGROUND OF THE INVENTION

Uncontrolled weeds can outgrow and dominate crop fields. Even at lower levels of infestation, weeds in crop fields contribute to decreased crop yields by competing for water, light, nutrients, and space. Weeds also carry diseases or disease causing organisms which can be spread to the crop plants and further decrease crop yields.

Flumioxazin (N-(7-fluoro-3,4-dihydro-3-oxo-4-prop-2-ynyl-2H-1,4-benzoxazin-6-yl)cyclo-hex-1-ene-1,2-dicarboxamide) is a protoporphyrinogen oxidase inhibitor herbicide. Flumioxazin has been used as an herbicide to control broadleaf weeds in crops, including cereals.

One of the limitations on the formulation and use of flumioxazin is the poor solution stability in concentrated solutions. This poor solution stability affects the storage and handling of the flumioxazin formulations given the propensity to form precipitate during storage. Physical instability, including phase separation, crystallization of an active or inert ingredient, settling or sedimentation of a particulate component, gelling, agglomeration, etc., often do not become apparent immediately upon preparation of the composition, but instead are time-related.

An acceptable shelf-life for a particular product depends upon the product in question and the use to which it is put, and can vary from a few weeks to several months. Agricultural products are expected to remain stable under typical storage conditions for a minimum of one to two years.

The present invention is directed toward overcoming one or more of the problems discussed above.

### SUMMARY OF THE INVENTION

Provided herein are aqueous liquid herbicide compositions comprising flumioxazin (also referred to herein as “flumi”). In some embodiments, the composition comprises flumioxazin, one or more wetting agents, one or more dispersing agents, one or more antifoam agents, one or more antifreeze agents, one or more thickening agents, and one or more diluents. In some embodiments, the composition comprises about 40% to about 50% by weight flumioxazin.

The aqueous liquid herbicide compositions provided herein are suspension concentrates. The solid particles of the water-insoluble pesticide are suspended in the continuous aqueous phase of the composition, and the water-soluble pesticide, if present, is dissolved in the aqueous phase.

In some embodiments, the composition comprises about 40% to about 50% by weight flumioxazin, about 3% to about 5% by weight of one or more wetting agents, about 1% to about 3% by weight of one or more dispersing agents, about 0.1% to about 0.2% by weight antifoam agent, about 5% to about 7% by weight antifreeze agent, about 0.1% to about 0.2% by weight thickening agent, about 0.1% to about 0.2% by weight preservative, and about 30% to about 49% by weight diluent.

In some embodiments, the composition comprises about 45% by weight flumioxazin, about 4% by weight of one or more wetting agents, about 2.3% by weight of one or more dispersing agents, about 0.1% by weight antifoam agent, about 6% by weight antifreeze agent, about 0.15% by weight thickening agent, about 0.1% by weight preservative, and about 42% by weight diluent.

In some aspects, by way of example, the composition comprises more than 2 pounds per gallon flumioxazin. In some aspects, the composition is a 4 pound per gallon suspension concentrate of flumioxazin.

Also provided herein are aqueous liquid herbicide compositions comprising flumioxazin and 2,4-dichlorophenoxyacetic acid (2,4-D). In some embodiments, the composition comprises about 2% to about 3% by weight flumioxazin and about 30% to about 45% by weight 2,4-D acid. In some embodiments, the composition comprises about 2% to about 3% by weight flumioxazin and about 30% to about 45% by weight 2,4-D acid, one or more wetting agents, one or more dispersing agents, one or more antifoam agents, one or more antifreeze agents, one or more thickening agents, and one or more diluents.

In some embodiments, the composition comprises about 2% to about 3% by weight flumioxazin, about 40% by weight 2,4-D acid, about 1% to about 2% by weight of one or more wetting agents, about 4% to about 5% by weight of one or more dispersing agents, about 0.1% to about 0.2% by weight antifoam agent, about 4% to about 6% by weight antifreeze agent, about 0.1% to about 0.3% by weight thickening agent, about 0.1% to about 0.2% by weight preservative, and about 35% to about 49% by weight diluent.

In some embodiments, the composition comprises about 2.6% by weight flumioxazin and about 40% by weight 2,4-D acid. In some embodiments, the composition comprises about 2.6% by weight flumioxazin and about 40% by weight 2,4-D acid, about 1.5% by weight of one or more wetting agents, about 4.5% by weight of one or more dispersing agents, about 0.1% by weight antifoam agent, about 5% by weight antifreeze agent, about 0.22% by weight thickening agent, about 0.1% by weight preservative, and about 44% by weight diluent.

In some embodiments, the compositions herein further comprise about 5% to about 6% dicamba by weight.

In some embodiments, the compositions provided herein further comprise about 0.5% by weight pH adjuster, and/or about 0.5% to about 1.5% by weight chelating agent. The pH adjuster can be, for example, citric acid, and the chelating agent can be, for example, EDTA. In some embodiments, both citric acid and EDTA are necessary to provide a stabilized suspension concentrate.

In some formulations, the composition comprises about 2% to about 3% by weight flumioxazin, about 32% by weight 2,4-D acid, about 5% to about 6% dicamba, about 1% to about 2% by weight of one or more wetting agents, about 4% to about 5% by weight of one or more dispersing agents, about 0.1% to about 0.2% by weight antifoam agent, about 4% to about 6% by weight antifreeze agent, about 0.1% to about 0.3% by weight thickening agent, about 0.1% to about 0.2% by weight preservative, and about 35% to about 49% by weight diluent.

In some formulations, the composition comprises about 2.7% by weight flumioxazin, about 32% by weight 2,4-D acid, about 5.2% by weight dicamba, about 1.5% by weight of one or more wetting agents, about 4.5% by weight of one or more dispersing agents, about 0.1% by weight antifoam agent, about 5% by weight antifreeze agent, about 0.22% by weight thickening agent, about 0.1% by weight preservative, and about 35% to about 49% by weight diluent.

In some embodiments, the compositions provided herein further comprise about 0.5% by weight pH adjuster, and about 0.5% to about 1.5% by weight chelating agent. The pH adjuster can be, for example, citric acid, and the chelating agent can be, for example, EDTA. In some embodiments, both citric acid and EDTA are necessary to provide a stabilized suspension concentrate.

Further provided herein are aqueous liquid herbicide compositions comprising flumioxazin, metribuzin, and imazethapyr. In some embodiments, the compositions comprise about 5% to about 10% by weight flumioxazin, about 30% to about 35% by weight metribuzin, and about 5% to about 10% by weight imazethapyr. In some embodiments, the compositions further comprise one or more wetting agents, one or more dispersing agents, one or more antifoam agents, one or more antifreeze agents, one or more thickening agents, and one or more diluents.

In some embodiments, the composition comprises about 5% to about 6% by weight flumioxazin, about 32% by weight metribuzin, and about 5% to about 6% imazethapyr. In some embodiments, the composition further comprises about 3% to about 5% by weight of one or more wetting agents, about 1% to about 4% by weight of one or more dispersing agents, about 0.1% to about 0.2% by weight antifoam agent, about 5% to about 7% by weight antifreeze agent, about 0.1% to about 0.2% by weight preservative, and about 35% to about 49% by weight diluent.

In some embodiments, the composition comprises about 7% by weight flumioxazin, about 32% by weight metribuzin, about 5.7% by weight imazethapyr, about 4% by weight of one or more wetting agents, about 2.3% by weight of one or more dispersing agents, about 0.1% by weight antifoam agent, about 6% by weight antifreeze agent, about 0.1% by weight preservative, and about 35% to about 43% by weight diluent. In some aspects, the imazethapyr is in salt form.

In some embodiments, compositions provided herein further comprise about 1.5% by weight pH adjuster.

Also provided herein are methods of controlling undesirable plants. In some embodiments, the method comprises diluting the compositions described herein in water and applying an herbicidally effective amount of the diluted composition to the foliage of the undesirable plants or to the soil where the undesirable plants grow.

In some embodiments, the step of applying is performed prior to planting the soil with a crop. In some embodiments, the step of applying is performed after planting the soil with a crop. In some embodiments, the diluted composition is applied to a field where crop seeds have been sown or where crop seeds are to be sown. In some embodiments, the step of applying is performed prior to emergence of weeds. In some embodiments, the step of applying is performed after weed emergence. In some embodiments, the step of applying is performed after weed emergence and before crop seed emergence. In some embodiments, the step of applying is to weeds or soil in rows between crops such as tree and nut crops.

### DESCRIPTION

Provided herein are compositions of flumioxazin suspension concentrates and methods for applying these compositions to an area in need of weed control. Further provided are flumioxazin suspension concentrates containing one or more additional active ingredients, for example, metribuzin, 2,4-D, imazethepyr, and/or dicamba.

Flumioxazin is typically prepared as a tank mix from a water dispersible granule formulation. These water dispersible granule formulations while providing shelf stability, cause problems due to the high amounts of clay in the water dispersible granule formulation. The clay present in these formulations when used as tank mixes make spray tanks and hoses difficult to clean out, decreasing the useful life of spray equipment and requiring increased hours of labor to clean out the equipment after use.

In addition, herbicide applicators prefer liquids such as suspension concentrates over water dispersible granules when treating fields given the ease of using suspension concentrates over water dispersible granule formulations. Suspension concentrate formulations provided herein provide better mixing, better handling, and are better in bulk use relative to water dispersible granule formulations.

Suspension concentrates are referred to herein as aqueous liquid formulations or compositions. Suspension concentrates are aqueous compositions containing pesticides as fine particles dispersed in an aqueous medium. Suspension concentrates are desirable for several reasons, including that the liquid can be poured or pumped, can be easily diluted with water to a desired concentration, and do not require the use of water-immiscible organic solvents.

Typically, the water-insoluble ingredient in a suspension concentrate tends to separate from the rest of the formulation over time. The inventors have determined that flumioxazin can be formulated into a suspension concentrate thereby providing a superior product with excellent handling and mixing properties over water dispersible granule formulations and other suspension concentrate formulations containing flumioxazin. The inventors have determined that a suspension concentrate formulation comprising flumioxazin alone or in combination with any one or more of 2,4-D, dicamba, metribuzin, and imazethapyr has surprisingly improved long term storage stability, for example, stability for at least about 1 year, or at least about 2 years, or at least about 3 years, or at least about 4 years, over other aqueous flumioxazin formulations. Other surprising properties include decreased injury to crop plants grown in fields treated with the herbicide formulations provided herein. Finally, the suspension concentrates provided herein do not have the clean-out issues which plague end-users who use water dispersible granule formulations in spray tanks, or who use flowable flumioxazin formulations having high clay content in spray tanks.

Suspension concentrates provided herein contain finely particulate solid of one or more water-insoluble active ingredients dispersed in a continuous aqueous phase. The aqueous phase may contain one or more water-soluble active ingredients. Additional ingredients include dispersing agents and anti-settling additives.

The substantially water-insoluble active ingredient in a suspension concentrate provided herein can illustratively be a herbicide, plant growth regulator, algicide, fungicide, bactericide, viricide, insecticide, acaricide, nematicide or molluscicide, and are found suspended in the aqueous phase of the formulations as solid particles. The substantially water-insoluble active ingredient is sometimes referred to herein for brevity as a “water-insoluble” active ingredient even if it has measurable solubility in water. This active ingredient preferably has a solubility in deionized water at 20° C. not greater than about 100 mg/l.

The water-insoluble active ingredient can be flumioxazin. Other water-insoluble active ingredients can be included in the formulations: illustrative examples of such herbicides include aclonifen, atrazine, bensulfuron-methyl, benzofenap, bifenox, bromobutide, bromofenoxim, chlomethoxyfen, chlorbromuron, chlorimuron-ethyl, chlornitrofen, chlorotoluron, chlorthal-dimethyl, clomeprop, daimuron, desmedipham, dichlobenil, diflufenican, dimefuron, dinitramine, diuron, ethametsulfuron-methyl, fenoxaprop-ethyl, flamprop-methyl, flazasulfuron, flumetsulam, flumiclorac-pentyl, flupoxam, fluridone, flurtamone, isoproturon, isoxaben, isoxapyrifop, lactofen, lenacil, linuron, mefenacet, methabenzthiazuron, metobenzuron, naproanilide, neburon, norflurazon, oryzalin, oxadiazon, oxyfluorfen, phenmedipham, prodiamine, prometryn, propazine, propyzamide, pyrazolynate, pyrazosulfuron-ethyl, pyributicarb, quinclorac, quizalofop-ethyl, rimsulfuron, siduron, simazine, terbuthylazine, terbutryn, thiazopyr, tralkoxydim and trietazine.

The loading of the water-insoluble active ingredient in the composition as a whole depends on the active ingredient in question and the intended use of the composition. In general this loading is typically about 10 to about 500 g/l, for example, about 15 g/l, about 20 g/l, 25 g/l, about 30 g/l, about 31 g/l, about 32 g/l, about 33 g/l, about 34 g/l, about 35 g/l, about 40 g/l, about 45 g/l, about 50 g/l, about 55 g/l, about 60 g/l, about 65 g/l, about 70 g/l, about 75 g/l, about 80 g/l, about 85 g/l, about 90 g/l, about 95 g/l, about 100 g/l, about 105 g/l, about 110 g/l, about 115 g/l, about 120 g/l, about 125 g/l, about 130 g/l, about 135 g/l, about 140 g/l, about 145 g/l, about 150 g/l, about 155 g/l, about 160 g/l, about 165 g/l, about 170 g/l, about 175 g/l, about 180 g/l, about 185 g/l, about 190 g/l, about 195 g/l, about 200 g/l, about 205 g/l, about 210 g/l, about 215 g/l, about 220 g/l, about 225 g/l, about 230 g/l, about 235 g/l, about 240 g/l, about 245 g/l, about 250 g/l, about 255 g/l, about 260 g/l, about 265 g/l, about 270 g/l, about 275 g/l, about 280 g/l, about 285 g/l, about 290 g/l, about 295 g/l, about 300 g/l, about 305 g/l, about 310 g/l, about 315 g/l, about 320 g/l, about 325 g/l, about 330 g/l, about 335 g/l, about 340 g/l, about 345 g/l, about 350 g/l, about 355 g/l, about 360 g/l, about 365 g/l, about 370 g/l, about 375 g/l, about 380 g/l, about 385 g/l, about 390 g/l, about 395 g/l, about 400 g/l, about 405 g/l, about 410 g/l, about 415 g/l, about 420 g/l, about 425 g/l, about 430 g/l, about 435 g/l, about 440 g/l, about 445 g/l, about 450 g/l, about 455 g/l, about 460 g/l, about 465 g/l, about 470 g/l, about 475 g/l, about 480 g/l, about 485 g/l, about 490 g/l, about 495 g/l, or about 500 g/1. For example, flumioxazin can be present in the suspension concentrate composition in any one of these amounts, or about 32 g/1 or about 490 g/1.

The water-insoluble active can be milled into particles with diameters of about 1 to about 10 microns, or about 4 to about 7 microns, or about 5 microns, or about 1 to about 5 microns, or about 2 to about 3 microns. In some aspects, the mean particle size D50 is between 1 and 10 microns, between 2 and 9 microns, between 3 and 8 microns, between 1 and 5 microns, between 5 and 10 microns, or about 5 microns. In some aspects, the D90 particle size is 20 microns or less, 18 microns or less, 15 microns or less, or between 15 and 20 microns. When the herbicidal formulation is diluted in water, the solid particles are dispersed into water at high concentrations and are applied as solid particles to the soil or weeds.

The water-soluble active ingredient useful in the suspension concentrate formulations herein can illustratively be a herbicide, plant growth regulator, algicide, fungicide, bactericide, viricide, insecticide, acaricide, nematicide or molluscicide. It can be a water-soluble derivative, such as a salt, of an otherwise water-insoluble pesticide or plant growth regulator. The term “water-soluble” in relation to a pesticide or plant growth regulator or a salt thereof as used herein means having a solubility in deionized water at 20° C. sufficient to enable the water-soluble active ingredient to be dissolved completely in the aqueous phase of a composition of the invention at the desired concentration. Where an active ingredient compound is referred to herein as being water-soluble, but the compound itself is known not to be water-soluble as defined immediately above, it will be understood that the reference applies to water-soluble derivatives, more particularly water-soluble salts, of the compound.

In one embodiment of the invention, the water-soluble active ingredient is a herbicide or an agriculturally acceptable salt thereof. Water-soluble herbicides useful in compositions of the invention include without restriction acifluorfen, acrolein, amitrole, asulam, benazolin, bentazon, bialaphos, bromacil, bromoxynil, chloramben, chloroacetic acid, clopyralid, 2,4-D, 2,4-DB, dalapon, dicamba, dichlorprop, diclofop, difenzoquat, diquat, endothall, fenac, fenoxaprop, flamprop, fluazifop, fluoroglycofen, flupropanate, fomesafen, fosamine, glufosinate, glyphosate, haloxyfop, imazameth, imazamethabenz, imazethapyr, imazamox, imazapic, imazapyr, imazaquin, imazethapyr, ioxynil, MCPA, MCPB, mecoprop, methylarsonic acid, metribuzin, naptalam, nonanoic acid, paraquat, picloram, sulfamic acid, 2,3,6-TBA, trichloroacetic acid, triclopyr, and/or water-soluble salts thereof.

Active ingredients can come in various forms, as known to those skilled in the art. For example, glyphosate can be in the form of a salt, for example, potassium salt or isopropyl amine salt, and mixtures thereof.

The water-soluble active ingredient in the suspension concentrate, for example, an herbicide, is present at a concentration in the composition as a whole sufficient, upon dilution of the composition in a suitable volume of water and applied by spraying to the target locus, to be pesticidally, for example, herbicidally, effective. In a concentrate composition it is desirable to provide as high a concentration, or “loading”, of the water-soluble active ingredient as is possible and convenient. Depending on the active ingredient in question and the intended use of the composition, a loading of about 20 to about 500 g/1 can be desirable in the concentrate composition. In some embodiments, the loading of the active ingredient is about 25 g/l, about 30 g/l, about 35 g/l, about 40 g/l, about 45 g/l, about 50 g/l, about 55 g/l, about 60 g/l, about 65 g/l, about 70 g/l, about 75 g/l, about 80 g/l, about 85 g/l, about 90 g/l, about 95 g/l, about 100 g/l, about 105 g/l, about 110 g/l, about 115 g/l, about 120 g/l, about 125 g/l, about 130 g/l, about 135 g/l, about 140 g/l, about 145 g/l, about 150 g/l, about 155 g/l, about 160 g/l, about 165 g/l, about 170 g/l, about 175 g/l, about 180 g/l, about 185 g/l, about 190 g/l, about 195 g/l, about 200 g/l, about 205 g/l, about 210 g/l, about 215 g/l, about 220 g/l, about 225 g/l, about 230 g/l, about 235 g/l, about 240 g/l, about 245 g/l, about 250 g/l, about 255 g/l, about 260 g/l, about 265 g/l, about 270 g/l, about 275 g/l, about 280 g/l, about 285 g/l, about 290 g/l, about 295 g/l, about 300 g/l, about 305 g/l, about 310 g/l, about 315 g/l, about 320 g/l, about 325 g/l, about 330 g/l, about 335 g/l, about 340 g/l, about 345 g/l, about 350 g/l, about 355 g/l, about 360 g/l, about 365 g/l, about 370 g/l, about 375 g/l, about 380 g/l, about 385 g/l, about 390 g/l, about 395 g/l, about 400 g/l, about 405 g/l, about 410 g/l, about 415 g/l, about 420 g/l, about 425 g/l, about 430 g/l, about 435 g/l, about 440 g/l, about 445 g/l, about 450 g/l, about 455 g/l, about 460 g/l, about 465 g/l, about 470 g/l, about 475 g/l, about 480 g/l, about 485 g/l, about 490 g/l, about 495 g/l, or about 500 g/1.

In some aspects, the suspension concentrate has a pH that is essentially neutral. In other aspects, the pH is acidic, i.e. between about 3 and 5 or between about 4 and 6. When the formulation is diluted in a spray tank, the pH typically reflects the pH of the water and the other products in the tank, if any.

In some aspects, the aqueous liquid herbicide (suspension concentrate composition or formulation, interchangeable herein) comprises flumioxazin as the water-insoluble ingredient. In some aspects, the aqueous liquid herbicide comprises flumioxazin and 2,4-D (or 2,4-D acid or 2,4-D amine). In some aspects, the aqueous liquid herbicide comprises flumioxazin, 2,4-D (or 2,4-D acid or 2,4-D amine), and dicamba. In some aspects, the aqueous liquid herbicide comprises metribuzin, flumioxazin, and imazethapyr. In some aspects, glyphosate is added to the flumioxazin formulations.

In other aspects, the aqueous liquid herbicide consists essentially of flumioxazin, or flumioxazin and glyphosate. In some aspects, the aqueous liquid herbicide consists essentially of flumioxazin and 2,4-D (or 2,4-D acid or 2,4-D amine), or flumioxazin, 2,4-D, and glyphosate. In some aspects, the aqueous liquid herbicide consists essentially of flumioxazin, 2,4-D (or 2,4-D acid or 2,4-D amine), and dicamba, with or without glyphosate. In some aspects, the aqueous liquid herbicide consists essentially of metribuzin, flumioxazin, and imazethapyr, with or without glyphosate.

In still other aspects, the aqueous liquid herbicide consists of flumioxazin as the only active ingredient. In some aspects, the aqueous liquid herbicide consists of flumioxazin and 2,4-D (or 2,4-D acid or 2,4-D amine) as the only active ingredients. In some aspects, the aqueous liquid herbicide consists of flumioxazin, 2,4-D (or 2,4-D acid or 2,4-D amine), and dicamba as the only active ingredients. In some aspects, the aqueous liquid herbicide consists of metribuzin, flumioxazin, and imazethapyr as the only active ingredients. Additional non-active ingredients are added to form the suspension concentrate, and can include one or more wetting agents, one or more dispersing agents, one or more antifoaming agents, one or more antifreeze agents, one or more chelating agents, one or more thickening agents, one or more preservatives, and one or more pH adjusting agents.

In still other aspects, the aqueous liquid herbicide consists of flumioxazin and glyphosate as the only active ingredients. In some aspects, the aqueous liquid herbicide consists of flumioxazin, 2,4-D (or 2,4-D acid or 2,4-D amine), and glyphosate as the only active ingredients. In some aspects, the aqueous liquid herbicide consists of flumioxazin, 2,4-D (or 2,4-D acid or 2,4-D amine), dicamba, and glyphosate as the only active ingredients. In some aspects, the aqueous liquid herbicide consists of metribuzin, flumioxazin, imazethapyr, and glyphosate as the only active ingredients. Additional non-active ingredients are added to form the suspension concentrate, and can include one or more wetting agents, one or more dispersing agents, one or more antifoaming agents, one or more antifreeze agents, one or more chelating agents, one or more thickening agents, one or more preservatives, and one or more pH adjusting agents.

When the suspension concentrate contains flumioxazin as the only active ingredient, the inventors determined that additional dispersing agent was useful in prolonging the shelf stability of the product.

The formulations provided herein can be prepared according to the exemplary processes provided below, but one of skill in the art would know that the formulations could be prepared by other processes.

In a first exemplary process, in a suitable container, water, dispersing agents, surfactants, wetting agents, a portion of the antifoam, and a portion of both water and glycol are mixed. To this mixture, insoluble active ingredients are mixed. This slurry is then milled to a desirable particle size, for example to about 2 to about 3 microns. A thickening solution, prepared in advance, any remaining water, glycol, antifoaming agents and preservatives would be added to the milled slurry to create the finished composition of the invention.

In a second process, aqueous ammonia is added to the one or more water soluble active ingredients, for example, imazethapyr, until the pH reaches 7. The imazethapyr/ammonium solution is combined with mill base water and the remaining water insoluble active ingredients are added in normal suspension concentrate order. The composition is milled to desirable particle size, for example to about 2 to about 3 microns. Thickener, prepared in advance, is added and viscosity is adjusted to the desired level for a finished composition of the invention. The formulations provided herein can include additional ingredients such as dispersing agents, wetting agents, antifoaming agents antifreeze agents, thickening agents, preservatives, pH adjusting agents, chelating agents, and diluents.

In some aspects, the formulations provided herein comprising flumioxazin in combination with one or more additional actives exhibit prolonged shelf stability in the presence of a chelating agent, such as EDTA, and citric acid.

In some aspects, the formulations provided herein comprising flumioxazin in combination with 2,4-D did not lose activity as expected. While not wishing to be held to theory, the maintaining of activity could be due to the levels of EDTA and citric acid in the suspension concentrate formulation.

Exemplary dispersing agents include ATLOX™ 4894, a nonionic proprietary surfactant blend. ATLOX™ 4894 is a gel at room temperature and has an HLB of 16. ATTAGEL™ 50 is another dispersing agent, an inert powdered gelling grade of attapulgite. It is finely pulverized (9 microns) to effectively form colloidal gels in ionic and non-ionic aqueous solutions to provide thixotropic thickening and suspension. The chemical composition is (Mg,Al)₅Si₈O₂O.4H₂O. Yet another dispersing agent is MORWET® D-425, a sodium salt of naphthalene sulfonate condensate. Yet still another dispersing agent is REAX® 907, a low salt, low-conductance, neutral pH dispersant used in liquid systems.

Exemplary wetting agents include ATLOX™ 4913, a polymeric surfactant with an HLB of 12. At 25° C., the surfactant is a liquid. The surfactant functions as an aqueous dispersant and crystal growth inhibitor. MORWET® EFW is another wetting agent, a blend of alkyl naphthalene sulfonate and an anionic wetting agent. This wetting agent assists granule breakdown in high concentration systems.

Exemplary antifoaming agents include SAG*™ 30, an emulsion useful for foam control in non-ionic surfactant systems, even in solutions diluted with water.

Propylene glycol is an exemplary antifreeze agent. Glycerin is another exemplary antifreeze agent.

Exemplary thickening agents include xanthan gum. Commercial grade xantham gum is sold under a variety of tradenames, including KELZAN® S and RHODOPOL® 23.

Exemplary preservatives include PROXEL™ BN (1,2-Benzisothiazolin-3-one (BIT) with 2-Bromo-2-nitropropan-1,3-diol (BNP)).

Chelating agents include, for example, Versene acid EDTA.

Citric acid and ammonium hydroxide are exemplary pH adjustors.

The formulations of the present invention can simply be diluted and can be applied to any environment in need of weed control. The environment in need of weed control may include any area that is desired to have a reduced number of weeds or to be free of weeds. For example, the mixture can be applied to an area used to grow crop plants, such as a field (including fallow fields), orchard, or vineyard or can be applied to bare ground in non-crop areas. The compositions can be applied to areas where winter oats, dry beans, sugarcane, sweet potato, soybeans, corn, peanuts, cotton, rice, sunflowers, tobacco, flax, pea, rye safflower, alfalfa, onion, mint, lentils, clover, oat, sugar beet, potato, clover, oats, or other crops/ornamentals will be grown. The crops may be GMO or non-GMO crops.

Compositions provided herein can be used for the control of a wide range of broad-leaved weeds, including marestale, Palmer amaranth, waterhemp, charlock, chickweed, cleavers, common poppy, field pansy, fumitory, groundsel, speedwells, mayweed, red deadnettle, coffee senna, common ragweed, dandelion, eclipta, evening primrose, false chamomile, Florida beggarweed, Florida pusley, golden crownbeard, hairy indigo, hemp sesbania, henbit, jimsonweed, kochia, lambsquarters, mustard, nightshades, pigweeds, prickly sida, puncturevine, purslane, radish, redmaids, redweed, smallflower morningglory, spurred anoda, tropic croton, venice mallow, waterhemp, wild poinsettia, and Shepherd's purse, as well as control of annual meadow grass, black-grass, and rye-grass. Compositions provided herein can be used to control other undesirable plants, including GMO or non-GMO plants.

Formulations provided herein can be diluted enough to be readily sprayed using standard agricultural spray equipment. Useful spray volumes can range from about 25 to about 1000 liters per hectare (1/ha) or higher, for example, about 100 to about 500 1/ha, by spray application.

In some embodiments, the compositions are applied at about 100 ml/hectare in a minimum water volume of about 200 litres per hectare and can be sprayed pre-crop emergence in all varieties of winter oats for the control of black-grass and rye-grass and a wide range of broad-leaved weeds.

The selection of application rates that are biologically effective for a specific pesticide and/or plant growth regulator package-mix composition is within the skill of the ordinary agricultural scientist. Those of skill in the art will likewise recognize that individual plant conditions, weather and growing conditions, as well as the specific active ingredients and their weight ratio in the composition, will influence the degree of biological effectiveness achieved in practicing this invention. The application rate is usually expressed as amount of active ingredient per unit area treated, e.g., grams per hectare (g/ha). What constitutes a “desired effect” varies according to the standards and practice of those who investigate, develop, market and use a specific class of pesticides or plant growth regulators. For example, in the case of a herbicide, the amount applied per unit area to give 85% control of a plant species as measured by growth reduction or mortality is often used to define a commercially effective rate.

The compositions can be applied by any convenient means. Those skilled in the art are familiar with the modes of application that include spraying.

Plant treatment compositions can be prepared simply by diluting a concentrate composition of the invention in water. Application of plant treatment compositions to a locus is preferably accomplished by spraying, using any conventional means for spraying liquids, such as spray nozzles, atomizers or the like. Compositions of the invention can be used in precision farming techniques, in which apparatus is employed to vary the amount of pesticide applied to different parts of a field, depending on variables such as the particular plant species present, soil composition, etc. In one embodiment of such techniques, a global positioning system operated with the spraying apparatus can be used to apply the desired amount of the composition to different parts of a field.

The compositions provided herein can be sprayed on the surface of soil before crops are sowed and before weeds grow; can be sprayed on the surface of soil before crops are sowed and after weeds grow; can be sprayed on weeds before crops are sowed and after the weeds grow; can be sprayed on the surface of soil after crops are sowed but before they germinate, and before weeds grow; can be sprayed on the surface of soil after crops are sowed but before they germinate, and after weeds grow; can be sprayed on weeds after crops are sowed but before they germinate, and after the weeds grow; can be sprayed on the surface of soil in the presence of crops before germination of weeds; can be sprayed on the surface of soil in the presence of crops after weeds grow; and/or can be sprayed on the surface of soil in the presence of crops after germination of the weeds.

The herbicide composition may be formulated to contain adjuvants, such as solvents, anti-caking agents, stabilizers, defoamers, slip agents, humectants, dispersants, wetting agents, thickening agents, emulsifiers, and preservatives which increase the long lasting activity of the active ingredients. Other components that enhance the biological activity of these ingredients may optionally be included.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight”. Therefore, amounts within 10% of the claimed values are encompassed by the scope of the claims.

The term “effective amount” means the amount of the formulation that will kill a weed. The “effective amount” will vary depending on the formulation concentration, the type of plants(s) being treated, the severity of the weed infestation, the result desired, and the life stage of the weeds during treatment, among other factors. Thus, it is not always possible to specify an exact “effective amount”. However, an appropriate “effective amount” in any individual case may be determined by one of ordinary skill in the art.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

### EXAMPLES

The following examples are provided for illustrative purposes only and are not intended to limit the scope of the invention.

### Example 1

### Flumioxazin Suspension Concentrate

A suspension concentrate containing flumioxazin as the only active ingredient was prepared according to Table 1.

TABLE 1
Flumioxazin Suspension Concentrate Formulation

| | Amount | | Ranges in % by Weight | |
|---|---|---|---|---|
| Ingredients | a. in Pounds | b. % by Weight | a. Upper Limit | b. Lower Limit |
| Flumioxazin 97%, | 449.4 | 44.94 | 46.28 | 43.59 |
| active ingredient | | 44.0% active | (44.32 ae) | (42.68 ae) |
| | | equivalent (ae) | | |
| ATLOX ™ 4894 Proprietary | 20.00 | 2.00 | 2.10 | 1.90 |
| dispersing agent from Croda Inc. | | | | |
| ATLOX ™ 4913 Proprietary | 40.00 | 4.00 | 4.20 | 3.80 |
| wetting agent from Croda Inc. | | | | |
| ATTAGEL ® 50 Dispersing | 3.00 | 0.3 | 0.33 | 0.27 |
| agent from BASF Corp. | | | | |
| SAG30 Proprietary antifoam | 1.00 | 0.10 | 0.11 | 0.09 |
| agent from Momentive | | | | |
| Propylene Glycol | 60.00 | 6.00 | 6.30 | 5.70 |
| Antifreeze agent | | | | |
| RHODOPOL ® 23 Thickening | 1.50 | 0.15 | 0.17 | 0.14 |
| agent from Rhodia Inc. | | | | |
| PROXEL ™ BN Preservative | 1.00 | 0.10 | 0.11 | 0.09 |
| from Arch Chemicals Inc. | | | | |
| Water | 424.1 | 42.41 | 43.68 | 41.14 |
| Total | 1000 lb | 100% | pH 6-7 neat | 9.1 lbs/gallon |

### Example 2

### Flumioxazin and 2,4-D Suspension Concentrate

A suspension concentrate containing flumioxazin and 2,4-D as the active ingredients was prepared according to Table 2.

TABLE 2
Flumioxazin and 2,4-D Suspension Concentrate Formulation

| | Amount | | Ranges in % by Weight | |
|---|---|---|---|---|
| Ingredients | a. in Pounds | b. % by Weight | a. Upper Limit | b. Lower Limit |
| Flumioxazin 97%, | 26.00 | 2.60 | 2.73 | 2.47 |
| active ingredient | | (2.53% ae) | (2.67 ae) | (2.40 ae) |
| 2,4-D Technical | 398.70 | 39.87 | 41.07 | 38.67 |
| Acid 97.5% | | (38.87% ae) | (40.04 ae) | (37.70 ae) |
| MORWET ® D-425 Proprietary | 30.00 | 3.00 | 3.15 | 2.85 |
| dispersing agent from Akzo Nobel | | | | |
| MORWET ® EFW Proprietary | 15.00 | 1.50 | 1.58 | 1.43 |
| wetting agent from Akzo Nobel | | | | |
| REAX907 Dispersing agent | 15.00 | 1.50 | 1.58 | 1.43 |
| from MeadWestvaco | | | | |
| SAG30 Proprietary antifoam | 1.00 | 0.10 | 0.11 | 0.09 |
| agent from Momentive | | | | |
| Propylene Glycol | 50.00 | 5.00 | 5.25 | 4.75 |
| Antifreeze agent | | | | |
| RHODOPOL ® 23 Thickening | 2.20 | 0.22 | 0.24 | 0.20 |
| agent from Rhodia Inc. | | | | |
| PROXEL ™ BN Preservative | 1.00 | 0.10 | 0.11 | 0.09 |
| from Arch Chemicals Inc. | | | | |
| Citric Acid pH Adjustor | 5.00 | 0.50 | 0.55 | 0.45 |
| Versene acid EDTA Chelating | 10.00 | 1.0 | 1.10 | 0.90 |
| Agent | | | | |
| Water | 446.1 | 44.61 | 45.95 | 43.27 |
| Total | 1000 lb | 100% | pH 2.5-3.5 neat | 10.29 lbs/gallon |

### Example 3

### Flumioxazin, 2,4-D, and Dicamba Suspension Concentrate

A suspension concentrate containing flumioxazin, 2,4-D, and dicamba as the active ingredients was prepared according to Table 3.

TABLE 3
Flumioxazin, 2,4-D, and Dicamba Suspension
Concentrate Formulation

| | Amount | |
|---|---|---|
| Ingredients | a. in Pounds | b. % by Weight |
| Flumioxazin 98%, | 0.2652 | 2.73 |
| active ingredient | | |
| 2,4-D Technical Acid 97%, | 3.0914 | 31.77 |
| active ingredient | | |
| Dicamba 98%, active ingredient | 0.5100 | 5.24 |
| MORWET ™ D-425 Proprietary | 0.2919 | 3.00 |
| dispersing agent from Akzo Nobel | | |
| MORWET ™ EFW Proprietary | 0.1459 | 1.50 |
| wetting agent from Akzo Nobel | | |
| REAX907 Dispersing agent | 0.1459 | 1.50 |
| from MeadWestvaco | | |
| SAG30 Proprietary antifoam | 0.0097 | 0.10 |
| agent from Momentive | | |
| Propylene Glycol | 0.4865 | 5.00 |
| Antifreeze agent | | |
| RHODOPOL ® 23 Thickening | 0.0214 | 0.22 |
| agent from Rhodia Inc. | | |
| PROXEL ™ BN Preservative | 0.0097 | 0.10 |
| from Arch Chemicals Inc. | | |
| Citric Acid pH Adjustor | 0.0486 | 0.50 |
| EDTA Chelating Agent | 0.0973 | 1.0 |
| Water | 4.606 | 47.34 |
| Total | 9.729 lb | 100% |
| | pH 3.2 neat | 9.729 lbs/gallon |

### Example 4

### Flumioxazin, Metribuzin, and Imazethapyr Suspension Concentrate

A suspension concentrate containing flumioxazin, metribuzin, and imazethapyr was prepared according to Table 4.

TABLE 4
Flumioxazin, Metribuzin, and Imazethapyr
Suspension Concentrate Formulation

| | Amount | |
|---|---|---|
| Ingredients | a. in grams | b. % by Weight |
| Flumioxazin 97%, active ingredient | 92.36 | 7.26 |
| Metribuzin | 413.47 | 32.48 |
| Imazethapyr | 73.05 | 5.74 |
| Ammonium Hydroxide, 28% | 19.89 | 1.56 |
| ATLOX ™ 4894 Proprietary | 25.46 | 2.00 |
| dispersing agent from Croda Inc. | | |
| ATLOX ™ 4913 Proprietary | 50.92 | 4.00 |
| wetting agent from Croda Inc. | | |
| ATTAGEL 50 Dispersing agent | 3.82 | 0.3 |
| from BASF Corp. | | |
| SAG30 Proprietary antifoam | 1.27 | 0.10 |
| agent from Momentive | | |
| Propylene Glycol | 76.38 | 6.00 |
| Antifreeze agent | | |
| KELZAN ® S Thickening | 1.91 | 0.15 |
| agent from CP Kelco | | |
| PROXEL ™ BN Preservative | 1.27 | 0.10 |
| from Arch Chemicals Inc. | | |
| Water | 513.2 | 40.31 |
| Total | 1273.00 g | 100% |

TABLE 5
Flumioxazin, Metribuzin, and Imazethapyr
Suspension Concentrate Formulation

| Active | | | | | lbs | lbs |
|---|---|---|---|---|---|---|
| Ingredients | % AI | % AE | g AI/L | g AE/L | Al/gal | AE/gal |
| Metribuzin | 31.83 | 31.83 | 360.00 | 360.00 | 3.00 | 3.000 |
| Flumioxazin | 7.11 | 7.11 | 80.40 | 80.40 | 0.67 | 0.670 |
| Imazethapyr | 6.74 | 5.62 | 76.19 | 63.60 | 0.63 | 0.530 |

AE = acid equivalents
AI = active ingredient

Procedure: in a separate beaker add imazethapyr and slowly add aqueous ammonia until the pH reaches 7. Prepare the thickener, and add imazethapyr ammonium solution to millbase water. Add remaining herbicides, wetting agents, dispersing agents, and anti-foam agent. Mill composition using standard wet milling to a particle size of 2-3 microns, and use laser scattering to verify size. Add thickener, preservative, and propylene glycol; measure and adjust viscosity to desired level.

### Example 5

Field experiments were performed in conventional till or no-till fields to evaluate weed control at various time-points after treatment. The data provide % weed control for treatments with various herbicide formulations or herbicide combinations on preemergent weeds and postemergent weeds in fallow fields.

The following tables provide data collected on various types of weeds using formulations from Example 1 and Example 2 in comparison to several other herbicide treatments and combinations.

TABLE 6
Percent Control of Annual Bluegrass

| | % Control | | | | |
|---|---|---|---|---|---|
| Annual Bluegrass | Poa | Poa | Poa | Poa | Poa |
| Field Plot Treatments | 7D | 15D | 29D | 57D | 112D |
| Flumi + 2,4-D | 0 | 22 | 36 | 40 | 38 |
| (SC of Example 2, 16 oz) | | | | | |
| Flumi + 2,4-D | 0 | 24 | 37 | 34 | 37 |
| (SC of Example 2, 32 oz) | | | | | |
| 2,4-D amine (16 oz) + Flumi | 2 | 21 | 27 | 28 | 26 |
| (Example 1, 1 oz) Tank mix | | | | | |
| 2,4-D amine (32 oz) + Flumi | 4 | 22 | 30 | 32 | 30 |
| (Example 1, 2 oz) Tank mix | | | | | |
| Spitfire ® Herbicide (20 oz) + | 0 | 2 | 10 | 14 | 13 |
| COC (crop oil concentrate) | | | | | |
| (dicamba + 2,4-D ester) | | | | | |
| Spitfire ® (32 oz) + COC | 0 | 7 | 13 | 17 | 17 |
| (dicamba + 2,4-D ester) | | | | | |
| Flumi (Example 1, 2 oz) + COC | 3 | 21 | 32 | 34 | 37 |
| Credit ® Xtreme Herbicide | 0 | 31 | 91 | 99 | 96 |
| (22 oz) + AMSv (mixture of | | | | | |
| potassium and isopropyl | | | | | |
| amine salts of glyphosate) | | | | | |
| Spitfire ® (20 oz) + Flumi | 3 | 24 | 27 | 26 | 24 |
| (Example 1, 1 oz) | | | | | |
| Spitfire ® (20 oz) + Flumi | 3 | 26 | 31 | 32 | 36 |
| (Example 1, 2 oz) | | | | | |
| Spitfire ® (32 oz) + Flumi | 2 | 24 | 31 | 34 | 27 |
| (Example 1, 1 oz) | | | | | |
| Spitfire ® (32 oz) + Flumi | 5 | 28 | 32 | 35 | 34 |
| (Example 1, 2 oz) | | | | | |
| Spitfire ® (20 oz) + Credit ® | 3 | 30 | 89 | 100 | 98 |
| Xtreme (22 oz) + AMS | | | | | |
| Spitfire ® (20 oz) + Flumi | 3 | 43 | 96 | 99 | 97 |
| (Example 1, 1 oz) + Credit ® | | | | | |
| Xtreme (22 oz) + AMS | | | | | |
| Flumi + 2,4-D (SC of Example 2, | 0 | 37 | 95 | 100 | 97 |
| 16 oz) + Credit ® Xtreme | | | | | |
| (22 oz) + AMS | | | | | |

*Crop Oil Concentrate @ 1% v/v added to all treatments

TABLE 7
Percent Control of Henbit

| Henbit #1 | % Control | | | | |
|---|---|---|---|---|---|
| Field Plot Treatments | 7D | 15D | 29D | 57D | 112D |
| Flumi + 2,4-D | 25 | 82 | 99 | 100 | 99 |
| (SC of Example 2, 16 oz) | | | | | |
| Flumi + 2,4-D | 30 | 82 | 100 | 100 | 100 |
| (SC of Example 2, 32 oz) | | | | | |
| 2,4-D amine (16 oz) + Flumi | 30 | 80 | 97 | 98 | 94 |
| (Example 1, 1 oz) Tank mix | | | | | |
| 2,4-D amine (32 oz) + Flumi | 34 | 83 | 99 | 99 | 98 |
| (Example 1, 2 oz) Tank mix | | | | | |
| Spitfire ® (20 oz) + COC | 9 | 12 | 22 | 30 | 16 |
| (dicamba + 2,4-D ester) | | | | | |
| Spitfire ® (32 oz) + COC | 9 | 27 | 36 | 53 | 46 |
| (dicamba + 2,4-D ester) | | | | | |
| Flumi (Example 1, 2 oz) + COC | 26 | 86 | 98 | 100 | 100 |
| Credit ® Xtreme (22 oz) + AMS | 12 | 67 | 88 | 100 | 98 |
| (mixture of potassium and | | | | | |
| isopropyl amine salts | | | | | |
| of glyphosate) | | | | | |
| Spitfire ® (20 oz) + Flumi | 26 | 76 | 93 | 98 | 96 |
| (Example 1, 1 oz) | | | | | |
| Spitfire ® (20 oz) + Flumi | 29 | 84 | 99 | 99 | 100 |
| (Example 1, 2 oz) | | | | | |
| Spitfire ® (32 oz) + Flumi | 27 | 85 | 100 | 100 | 100 |
| (Example 1, 1 oz) | | | | | |
| Spitfire ® (32 oz) + Flumi | 28 | 83 | 100 | 100 | 99 |
| (Example 1, 2 oz) | | | | | |
| Spitfire ® (20 oz) + Credit ® | 16 | 65 | 94 | 99 | 97 |
| Xtreme (22 oz) + AMS | | | | | |
| Spitfire ® (20 oz) + Flumi | 22 | 77 | 99 | 100 | 99 |
| (Example 1, 1 oz) + Credit ® | | | | | |
| Xtreme (22 oz) + AMS | | | | | |
| Flumi + 2,4-D (SC of Example 2, | 18 | 79 | 100 | 100 | 100 |
| 16 oz) + Credit ® Xtreme | | | | | |
| (22 oz) + AMS | | | | | |

*COC @ 1% v/v added to all treatments

TABLE 8
Percent Control of Henbit

| | % Control | |
|---|---|---|
| Henbit #2 | 15 | 26 |
| Field Plot Treatments | DAT | DAT |
| Flumi + 2,4-D (SC of Example 2, 16 oz) | 50 | 71 |
| Flumi + 2,4-D (SC of Example 2, 32 oz) | 65 | 81 |
| 2,4-D amine (16 oz) + Flumi (Example 1, 1 oz) | 44 | 65 |
| Tank mix | | |
| 2,4-D amine (32 oz) + Flumi (Example 1, 2 oz) | 48 | 78 |
| Tank mix | | |
| Spitfire ® (20 oz) + COC (dicamba + 2,4-D ester) | 41 | 55 |
| Spitfire ® (32 oz) + COC (dicamba + 2,4-D ester) | 38 | 56 |
| Flumi (Example 1, 2 oz) + COC | 58 | 78 |
| Credit ® Xtreme (22 oz) + AMS (mixture of | 59 | 71 |
| potassium and isopropyl amine salts | | |
| of glyphosate) | | |
| Spitfire ® (20 oz) + Flumi (Example 1, 1 oz) | 71 | 86 |
| Spitfire ® (20 oz) + Flumi (Example 1, 2 oz) | 69 | 91 |
| Spitfire ® (32 oz) + Flumi (Example 1, 1 oz) | 70 | 90 |
| Spitfire ® (32 oz) + Flumi (Example 1, 2 oz) | 81 | 93 |
| Spitfire ® (20 oz) + Credit ® Xtreme | 41 | 63 |
| (22 oz) + AMS | | |
| Spitfire ® (20 oz) + Flumi (Example 1, 1 oz) + | 64 | 94 |
| Credit ® Xtreme (22 oz) + AMS | | |
| Flumi + 2,4-D (SC of Example 2, 16 oz) + | 51 | 89 |
| Credit ® Xtreme (22 oz) + AMS | | |

*COC @ 1% v/v added to all treatments

TABLE 9
Percent Control of Cutleaf Eveningprimrose

| | % Control | |
|---|---|---|
| Cutleaf Eveningprimrose | 15 | 26 |
| Field Plot Treatments | DAT | DAT |
| Flumi + 2,4-D (SC of Example 2, 16 oz) | 59 | 78 |
| Flumi + 2,4-D (SC of Example 2, 32 oz) | 73 | 84 |
| 2,4-D amine (16 oz) + Flumi (Example 1, 1 oz) | 56 | 73 |
| Tank mix | | |
| 2,4-D amine (32 oz) + Flumi (Example 1, 2 oz) | 60 | 76 |
| Tank mix | | |
| Spitfire ® (20 oz) + COC (dicamba + 2,4-D ester) | 64 | 75 |
| Spitfire ® (32 oz) + COC (dicamba + 2,4-D ester) | 54 | 80 |
| Flumi (Example 1, 2 oz) + COC | 68 | 79 |
| Credit ® Xtreme (22 oz) + AMS (mixture of | 40 | 53 |
| potassium and isopropyl amine salts | | |
| of glyphosate) | | |
| Spitfire ® (20 oz) + Flumi (Example 1, 1 oz) | 76 | 89 |
| Spitfire ® (20 oz) + Flumi (Example 1, 2 oz) | 78 | 93 |
| Spitfire ® (32 oz) + Flumi (Example 1, 1 oz) | 73 | 90 |
| Spitfire ® (32 oz) + Flumi (Example 1, 2 oz) | 83 | 95 |
| Spitfire ® (20 oz) + Credit ® Xtreme | 51 | 64 |
| (22 oz) + AMS | | |
| Spitfire ® (20 oz) + Flumi (Example 1, 1 oz) + | 69 | 89 |
| Credit ® Xtreme (22 oz) + AMS | | |
| Flumi + 2,4-D (SC of Example 2, 16 oz) + | 63 | 89 |
| Credit ® Xtreme (22 oz) + AMS | | |

*COC @ 1% v/v added to all treatments

TABLE 10
Percent Control of Mayweed Chamomile

| | % Control | |
|---|---|---|
| Mayweed Chamomile | 15 | 26 |
| Field Plot Treatments | DAT | DAT |
| Flumi + 2,4-D (SC of Example 2, 16 oz) | 59 | 64 |
| Flumi + 2,4-D (SC of Example 2, 32 oz) | 69 | 73 |
| 2,4-D amine (16 oz) + Flumi (Example 1, 1 oz) | 51 | 55 |
| Tank mix | | |
| 2,4-D amine (32 oz) + Flumi (Example 1, 2 oz) | 54 | 60 |
| Tank mix | | |
| Spitfire ® (20 oz) + COC (dicamba + 2,4-D ester) | 48 | 55 |
| Spitfire ® (32 oz) + COC (dicamba + 2,4-D ester) | 44 | 55 |
| Flumi (Example 1, 2 oz) + COC | 54 | 51 |
| Credit ® Xtreme (22 oz) + AMS (mixture of | 48 | 79 |
| potassium and isopropyl amine salts | | |
| of glyphosate) | | |
| Spitfire ® (20 oz) + Flumi (Example 1, 1 oz) | 61 | 65 |
| Spitfire ® (20 oz) + Flumi (Example 1, 2 oz) | 64 | 68 |
| Spitfire ® (32 oz) + Flumi (Example 1, 1 oz) | 64 | 69 |
| Spitfire ® (32 oz) + Flumi (Example 1, 2 oz) | 78 | 80 |
| Spitfire ® (20 oz) + Credit ® Xtreme | 50 | 84 |
| (22 oz) + AMS | | |
| Spitfire ® (20 oz) + Flumi (Example 1, 1 oz) + | 71 | 94 |
| Credit ® Xtreme (22 oz) + AMS | | |
| Flumi + 2,4-D (SC of Example 2, 16 oz) + | 56 | 93 |
| Credit ® Xtreme (22 oz) + AMS | | |

*COC @ 1% v/v added to all treatments

TABLE 11
Percent Control of Curly Dock

| | % Control | |
|---|---|---|
| Curly Dock | 15 | 26 |
| Field Plot Treatments | DAT | DAT |
| Flumi + 2,4-D (SC of Example 2, 16 oz) | 58 | 55 |
| Flumi + 2,4-D (SC of Example 2, 32 oz) | 69 | 71 |
| 2,4-D amine (16 oz) + Flumi (Example 1, 1 oz) | 54 | 60 |
| Tank mix | | |
| 2,4-D amine (32 oz) + Flumi (Example 1, 2 oz) | 65 | 58 |
| Tank mix | | |
| Spitfire ® (20 oz) + COC (dicamba + 2,4-D ester) | 68 | 76 |
| Spitfire ® (32 oz) + COC (dicamba + 2,4-D ester) | 63 | 81 |
| Flumi (Example 1, 2 oz) + COC | 59 | 69 |
| Credit ® Xtreme (22 oz) + AMS (mixture of | 45 | 63 |
| potassium and isopropyl amine salts | | |
| of glyphosate) | | |
| Spitfire ® (20 oz) + Flumi (Example 1, 1 oz) | 74 | 80 |
| Spitfire ® (20 oz) + Flumi (Example 1, 2 oz) | 75 | 86 |
| Spitfire ® (32 oz) + Flumi (Example 1, 1 oz) | 79 | 84 |
| Spitfire ® (32 oz) + Flumi (Example 1, 2 oz) | 84 | 89 |
| Spitfire ® (20 oz) + Credit ® Xtreme | 55 | 69 |
| (22 oz) + AMS | | |
| Spitfire ® (20 oz) + Flumi (Example 1, 1 oz) + | 68 | 79 |
| Credit ® Xtreme (22 oz) + AMS | | |
| Flumi + 2,4-D (SC of Example 2, 16 oz) + | 53 | 74 |
| Credit ® Xtreme (22 oz) + AMS | | |

*COC @ 1% v/v added to all treatments

TABLE 12
Percent Control of Italian Ryegrass

| | % Control | |
|---|---|---|
| Italian Ryegrass | 15 | 26 |
| Field Plot Treatments | DAT | DAT |
| Flumi + 2,4-D (SC of Example 2, 16 oz) | 53 | 51 |
| Flumi + 2,4-D (SC of Example 2, 32 oz) | 46 | 55 |
| 2,4-D amine (16 oz) + Flumi (Example 1, 1 oz) | 36 | 48 |
| Tank mix | | |
| 2,4-D amine (32 oz) + Flumi (Example 1, 2 oz) | 51 | 58 |
| Tank mix | | |
| Spitfire ® (20 oz) + COC (dicamba + 2,4-D ester) | 51 | 53 |
| Spitfire ® (32 oz) + COC (dicamba + 2,4-D ester) | 39 | 55 |
| Flumi (Example 1, 2 oz) + COC | 54 | 55 |
| Credit ® Xtreme (22 oz) + AMS (mixture of | 61 | 85 |
| potassium and isopropyl amine salts | | |
| of glyphosate) | | |
| Spitfire ® (20 oz) + Flumi (Example 1, 1 oz) | 65 | 69 |
| Spitfire ® (20 oz) + Flumi (Example 1, 2 oz) | 63 | 68 |
| Spitfire ® (32 oz) + Flumi (Example 1, 1 oz) | 63 | 69 |
| Spitfire ® (32 oz) + Flumi (Example 1, 2 oz) | 64 | 65 |
| Spitfire ® (20 oz) + Credit ® Xtreme | 55 | 83 |
| (22 oz) + AMS | | |
| Spitfire ® (20 oz) + Flumi (Example 1, 1 oz) + | 65 | 83 |
| Credit ® Xtreme (22 oz) + AMS | | |
| Flumi + 2,4-D (SC of Example 2, 16 oz) + | 56 | 79 |
| Credit ® Xtreme (22 oz) + AMS | | |

*COC @ 1% v/v added to all treatments

TABLE 13
Percent Control of Marestail

| | % Control | | |
|---|---|---|---|
| Marestail #1 | 8 | 17 | 24 |
| Field Plot Treatment | DAT | DAT | DAT |
| Flumi + 2,4-D (SC of Example 2, 16 oz) | 71 | 68 | 63 |
| Flumi + 2,4-D (SC of Example 2, 32 oz) | 76 | 94 | 97 |
| 2,4-D amine (16 oz) + Flumi (Example 1, 1 oz) | 69 | 62 | 55 |
| Tank mix | | | |
| 2,4-D amine (32 oz) + Flumi (Example 1, 2 oz) | 78 | 98 | 90 |
| Tank mix | | | |
| Spitfire ® (20 oz) + COC (dicamba + 2,4-D | 66 | 90 | 93 |
| ester) | | | |
| Spitfire ® (32 oz) + COC (dicamba + 2,4-D | 68 | 92 | 93 |
| ester) | | | |
| Flumi (Example 1, 2 oz) + COC | 0 | 0 | 5 |
| Credit ® Xtreme (22 oz) + AMS (mixture of | 1 | 20 | 11 |
| potassium and isopropyl amine salts | | | |
| of glyphosate) | | | |
| Spitfire ® (20 oz) + Flumi (Example 1, 1 oz) | 74 | 96 | 95 |
| Spitfire ® (20 oz) + Flumi (Example 1, 2 oz) | 81 | 96 | 98 |
| Spitfire ® (32 oz) + Flumi (Example 1, 1 oz) | 80 | 98 | 99 |
| Spitfire ® (32 oz) + Flumi (Example 1, 2 oz) | 82 | 91 | 96 |
| Spitfire ® (20 oz) + Credit ® Xtreme | 65 | 94 | 94 |
| (22 oz) + AMS | | | |
| Spitfire ® (20 oz) + Flumi (Example 1, 1 oz) + | 87 | 98 | 98 |
| Credit ® Xtreme (22 oz) + AMS | | | |
| Flumi + 2,4-D (SC of Example 2, 16 oz) + | 59 | 70 | 49 |
| Credit ® Xtreme (22 oz) + AMS | | | |

*COC @ 1% v/v added to all treatments

TABLE 14
Percent Control of Henbit

| | % Control | | |
|---|---|---|---|
| Henbit #3 | 6 | 14 | 25 |
| Field Plot Treatments | DAT | DAT | DAT |
| Flumi + 2,4-D (SC of Example 2, 16 oz) | 55 | 97 | 98 |
| Flumi + 2,4-D (SC of Example 2, 32 oz) | 58 | 96 | 98 |
| 2,4-D amine (16 oz) + Flumi (Example 1, 1 oz) | 59 | 92 | 94 |
| Tank mix | | | |
| 2,4-D amine (32 oz) + Flumi (Example 1, 2 oz) | 60 | 95 | 96 |
| Tank mix | | | |
| Spitfire ® (20 oz) + COC (dicamba + 2,4-D | 50 | 53 | 61 |
| ester) | | | |
| Spitfire ® (32 oz) + COC (dicamba + 2,4-D | 53 | 55 | 69 |
| ester) | | | |
| Flumi (Example 1, 2 oz) + COC | 55 | 84 | 95 |
| Credit ® Xtreme (22 oz) + AMS (mixture of | 50 | 60 | 76 |
| potassium and isopropyl amine salts | | | |
| of glyphosate) | | | |
| Spitfire ® (20 oz) + Flumi (Example 1, 1 oz) | 55 | 97 | 97 |
| Spitfire ® (20 oz) + Flumi (Example 1, 2 oz) | 58 | 97 | 97 |
| Spitfire ® (32 oz) + Flumi (Example 1, 1 oz) | 56 | 95 | 97 |
| Spitfire ® (32 oz) + Flumi (Example 1, 2 oz) | 60 | 96 | 98 |
| Spitfire ® (20 oz) + Credit ® Xtreme | 54 | 59 | 75 |
| (22 oz) + AMS | | | |
| Spitfire ® (20 oz) + Flumi (Example 1, 1 oz) + | 58 | 94 | 98 |
| Credit ® Xtreme (22 oz) + AMS | | | |
| Flumi + 2,4-D (SC of Example 2, 16 oz) + | 59 | 92 | 99 |
| Credit ® Xtreme (22 oz) + AMS | | | |
| Roundup PowerMAX ® (glyphosate, potassium | 53 | 58 | 65 |
| salt, 22 oz) + Clarity ® (BASF, diglycolamine | | | |
| salt of 3,6-dichloro-o-anisic acid, 8 oz) | | | |

*COC @ 1% v/v added to all treatments except PowerMAX ® + Clarity ®

TABLE 15
Percent Control of Marestail

| | % Control | | |
|---|---|---|---|
| Marestail #2 | 6 | 14 | 25 |
| Field Plot Treatments | DAT | DAT | DAT |
| Flumi + 2,4-D (SC of Example 2, 16 oz) | 60 | 87 | 85 |
| Flumi + 2,4-D (SC of Example 2, 32 oz) | 58 | 85 | 85 |
| 2,4-D amine (16 oz) + Flumi (Example 1, 1 oz) | 59 | 86 | 82 |
| Tank mix | | | |
| 2,4-D amine (32 oz) + Flumi (Example 1, 2 oz) | 63 | 89 | 83 |
| Tank mix | | | |
| Spitfire ® (20 oz) + COC (dicamba + 2,4-D | 55 | 80 | 72 |
| ester) | | | |
| Spitfire ® (32 oz) + COC (dicamba + 2,4-D | 58 | 78 | 76 |
| ester) | | | |
| Flumi (Example 1, 2 oz) + COC | 53 | 59 | 50 |
| Credit ® Xtreme (22 oz) + AMS (mixture of | 45 | 60 | 62 |
| potassium and isopropyl amine salts | | | |
| of glyphosate) | | | |
| Spitfire ® (20 oz) + Flumi (Example 1, 1 oz) | 59 | 86 | 87 |
| Spitfire ® (20 oz) + Flumi (Example 1, 2 oz) | 55 | 87 | 87 |
| Spitfire ® (32 oz) + Flumi (Example 1, 1 oz) | 60 | 86 | 92 |
| Spitfire ® (32 oz) + Flumi (Example 1, 2 oz) | 60 | 83 | 90 |
| Spitfire ® (20 oz) + Credit ® Xtreme | 54 | 84 | 91 |
| (22 oz) + AMS | | | |
| Spitfire ® (20 oz) + Flumi (Example 1, | 60 | 86 | 94 |
| 1 oz) + Credit ® Xtreme (22 oz) + AMS | | | |
| Flumi + 2,4-D (SC of Example 2, 16 oz) + | 61 | 87 | 93 |
| Credit ® Xtreme (22 oz) + AMS | | | |
| Roundup PowerMAX ® (glyphosate, potassium | 60 | 83 | 86 |
| salt, 22 oz) + Clarity ® (BASF, diglycolamine | | | |
| salt of 3,6-dichloro-o-anisic acid, 8 oz) | | | |

*COC @ 1% v/v added to all treatments except PowerMAX ® + Clarity ®

TABLE 16
Percent Control of Shepherd's Purse

| | % Control | | | |
|---|---|---|---|---|
| Shepherd's Purse | 7 | 18 | 28 | 69 |
| Field Plot Treatments | DAT | DAT | DAT | DAT |
| Flumi + 2,4-D (SC of Example 2, 16 oz) | 49 | 82 | 95 | 95 |
| Flumi + 2,4-D (SC of Example 2, 32 oz) | 65 | 91 | 95 | 94 |
| 2,4-D amine (16 oz) + Flumi | 33 | 79 | 91 | 91 |
| (Example 1, 1 oz) Tank mix | | | | |
| 2,4-D amine (32 oz) + Flumi | 59 | 92 | 97 | 97 |
| (Example 1, 2 oz) Tank mix | | | | |
| Spitfire ® (20 oz) + COC | 0 | 78 | 86 | 85 |
| (dicamba + 2,4-D ester) | | | | |
| Spitfire ® (32 oz) + COC | 3 | 55 | 95 | 95 |
| (dicamba + 2,4-D ester) | | | | |
| Flumi (Example 1, 2 oz) + COC | 21 | 36 | 59 | 59 |
| Credit ® Xtreme (22 oz) + AMS | 30 | 86 | 83 | 62 |
| (mixture of potassium and isopropyl | | | | |
| amine salts of glyphosate) | | | | |
| Spitfire ® (20 oz) + Flumi | 63 | 93 | 88 | 85 |
| (Example 1, 1 oz) | | | | |
| Spitfire ® (20 oz) + Flumi | 58 | 86 | 89 | 88 |
| (Example 1, 2 oz) | | | | |
| Spitfire ® (32 oz) + Flumi | 60 | 92 | 96 | 95 |
| (Example 1, 1 oz) | | | | |
| Spitfire ® (32 oz) + Flumi | 69 | 98 | 99 | 99 |
| (Example 1, 2 oz) | | | | |
| Spitfire ® (20 oz) + Credit ® | 31 | 90 | 85 | 80 |
| Xtreme (22 oz) + AMS | | | | |
| Spitfire ® (20 oz) + Flumi | 61 | 97 | 93 | 91 |
| (Example 1, 1 oz) + Credit ® | | | | |
| Xtreme (22 oz) + AMS | | | | |
| Flumi + 2,4-D (SC of Example 2, | 25 | 85 | 83 | 80 |
| 16 oz) + Credit ® Xtreme (22 oz) + AMS | | | | |

*COC @ 1% v/v added to all treatments

TABLE 17
Percent Control of Common Chickweed

| | % Control | | | |
|---|---|---|---|---|
| Common Chickweed | 7 | 18 | 28 | 69 |
| Field Plot Treatment | DAT | DAT | DAT | DAT |
| Flumi + 2,4-D (SC of Example 2, 16 oz) | 65 | 65 | 23 | 23 |
| Flumi + 2,4-D (SC of Example 2, 32 oz) | 62 | 58 | 88 | 73 |
| 2,4-D amine (16 oz) + Flumi | 38 | 38 | 17 | 28 |
| (Example 1, 1 oz) Tank mix | | | | |
| 2,4-D amine (32 oz) + Flumi | 68 | 60 | 75 | 63 |
| (Example 1, 2 oz) Tank mix | | | | |
| Spitfire ® (20 oz) + COC | 0 | 22 | 27 | 45 |
| (dicamba + 2,4-D ester) | | | | |
| Spitfire ® (32 oz) + COC | 2 | 17 | 45 | 34 |
| (dicamba + 2,4-D ester) | | | | |
| Flumi (Example 1, 2 oz) + COC | 75 | 35 | 87 | 65 |
| Credit ® Xtreme (22 oz) + AMS | 19 | 95 | 93 | 95 |
| (mixture of potassium and isopropyl | | | | |
| amine salts of glyphosate) | | | | |
| Spitfire ® (20 oz) + Flumi | 72 | 63 | 50 | 45 |
| (Example 1, 1 oz) | | | | |
| Spitfire ® (20 oz) + Flumi | 77 | 85 | 47 | 56 |
| (Example 1, 2 oz) | | | | |
| Spitfire ® (32 oz) + Flumi | 70 | 78 | 78 | 83 |
| (Example 1, 1 oz) | | | | |
| Spitfire ® (32 oz) + Flumi | 61 | 62 | 85 | 89 |
| (Example 1, 2 oz) | | | | |
| Spitfire ® (20 oz) + Credit ® | 19 | 88 | 87 | 90 |
| Xtreme (22 oz) + AMS | | | | |
| Spitfire ® (20 oz) + Flumi | 78 | 99 | 100 | 100 |
| (Example 1, 1 oz) + Credit ® | | | | |
| Xtreme (22 oz) + AMS | | | | |
| Flumi + 2,4-D (SC of Example 2, | 32 | 84 | 92 | 94 |
| 16 oz) + Credit ® Xtreme (22 oz) + AMS | | | | |

*COC @ 1% v/v added to all treatments

TABLE 18
Percent Control of Small-flowered Buttercup

| | % Control | | |
|---|---|---|---|
| Small-flowered Buttercup | 7 | 14 | 32 |
| Field Plot Treatments | DAT | DAT | DAT |
| Flumi + 2,4-D (SC of Example 2, 16 oz) | 40 | 60 | 83 |
| Flumi + 2,4-D (SC of Example 2, 32 oz) | 50 | 72 | 92 |
| 2,4-D amine (16 oz) + Flumi | 35 | 65 | 80 |
| (Example 1, 1 oz) Tank mix | | | |
| 2,4-D amine (32 oz) + Flumi | 63 | 90 | 100 |
| (Example 1, 2 oz) Tank mix | | | |
| Spitfire ® (20 oz) + COC | 18 | 38 | 80 |
| (dicamba + 2,4-D ester) | | | |
| Spitfire ® (32 oz) + COC | 30 | 55 | 100 |
| (dicamba + 2,4-D ester) | | | |
| Flumi (Example 1, 2 oz) + COC | 30 | 7 | 0 |
| Credit ® Xtreme (22 oz) + AMS | 9 | 80 | 100 |
| (mixture of potassium and isopropyl | | | |
| amine salts of glyphosate) | | | |
| Spitfire ® (20 oz) + Flumi | 57 | 55 | 83 |
| (Example 1, 1 oz) | | | |
| Spitfire ® (20 oz) + Flumi | 50 | 93 | 90 |
| (Example 1, 2 oz) | | | |
| Spitfire ® (32 oz) + Flumi | 49 | 93 | 95 |
| (Example 1, 1 oz) | | | |
| Spitfire ® (32 oz) + Flumi | 75 | 98 | 100 |
| (Example 1, 2 oz) | | | |
| Spitfire ® (20 oz) + Credit ® | 28 | 90 | 100 |
| Xtreme (22 oz) + AMS | | | |
| Spitfire ® (20 oz) + Flumi | 43 | 100 | 100 |
| (Example 1, 1 oz) + Credit ® | | | |
| Xtreme (22 oz) + AMS | | | |
| Flumi + 2,4-D (SC of Example 2, | 38 | 100 | 100 |
| 16 oz) + Credit ® Xtreme (22 oz) + AMS | | | |

*COC @ 1% v/v added to all treatments

TABLE 19
Percent Control of Small-flowered Buttercup

| | % Control | | |
|---|---|---|---|
| Wild Garlic | 7 | 14 | 32 |
| Field Plot Treatments | DAT | DAT | DAT |
| Flumi + 2,4-D (SC of Example 2, 16 oz) | 18 | 47 | 25 |
| Flumi + 2,4-D (SC of Example 2, 32 oz) | 37 | 40 | 48 |
| 2,4-D amine (16 oz) + Flumi | 37 | 39 | 13 |
| (Example 1, 1 oz) Tank mix | | | |
| 2,4-D amine (32 oz) + Flumi | 40 | 60 | 55 |
| (Example 1, 2 oz) Tank mix | | | |
| Spitfire ® (20 oz) + COC | 20 | 47 | ND |
| (dicamba + 2,4-D ester) | | | |
| Spitfire ® (32 oz) + COC | 40 | 55 | ND |
| (dicamba + 2,4-D ester) | | | |
| Flumi (Example 1, 2 oz) + COC | 8 | 3 | 0 |
| Credit ® Xtreme (22 oz) + AMS | 0 | 11 | 55 |
| (mixture of potassium and isopropyl | | | |
| amine salts of glyphosate) | | | |
| Spitfire ® (20 oz) + Flumi | 22 | 37 | 45 |
| (Example 1, 1 oz) | | | |
| Spitfire ® (20 oz) + Flumi | 45 | 40 | 65 |
| (Example 1, 2 oz) | | | |
| Spitfire ® (32 oz) + Flumi | 38 | 52 | 43 |
| (Example 1, 1 oz) | | | |
| Spitfire ® (32 oz) + Flumi | 38 | 60 | 45 |
| (Example 1, 2 oz) | | | |
| Spitfire ® (20 oz) + Credit ® | 25 | 38 | 85 |
| Xtreme (22 oz) + AMS | | | |
| Spitfire ® (20 oz) + Flumi | 50 | 50 | ND |
| (Example 1, 1 oz) + Credit ® | | | |
| Xtreme (22 oz) + AMS | | | |
| Flumi + 2,4-D (SC of Example 2, | 23 | 55 | 90 |
| 16 oz) + Credit ® Xtreme (22 oz) + AMS | | | |

*COC @ 1% v/v added to all treatments

TABLE 20
Percent Control of Philadelphia Fleabane

% Control

| Philadelphia Fleabane | 7 | 14 |
|---|---|---|
| Field Plot Treatments | DAT | DAT |
| Flumi + 2,4-D (SC of Example 2, 16 oz) | 58 | 75 |
| Flumi + 2,4-D (SC of Example 2, 32 oz) | 63 | 78 |
| 2,4-D amine (16 oz) + Flumi | 58 | 68 |
| (Example 1, 1 oz) Tank mix | | |
| 2,4-D amine (32 oz) + Flumi | 58 | 58 |
| (Example 1, 2 oz) Tank mix | | |
| Spitfire ® (20 oz) + COC | 48 | 60 |
| (dicamba + 2,4-D ester) | | |
| Spitfire ® (32 oz) + COC | 55 | 63 |
| (dicamba + 2,4-D ester) | | |
| Flumi (Example 1, 2 oz) + COC | 50 | 78 |
| Credit ® Xtreme (22 oz) + AMS | 38 | 88 |
| (mixture of potassium and isopropyl | | |
| amine salts of glyphosate) | | |
| Spitfire ® (20 oz) + Flumi | 60 | 65 |
| (Example 1, 1 oz) | | |
| Spitfire ® (20 oz) + Flumi | 68 | 73 |
| (Example 1, 2 oz) | | |
| Spitfire ® (32 oz) + Flumi | 60 | 63 |
| (Example 1, 1 oz) | | |
| Spitfire ® (32 oz) + Flumi | 56 | 71 |
| (Example 1, 2 oz) | | |
| Spitfire ® (20 oz) + Credit ® | 59 | 93 |
| Xtreme (22 oz) + AMS | | |
| Spitfire ® (20 oz) + Flumi | 65 | 88 |
| (Example 1, 1 oz) + Credit ® | | |
| Xtreme (22 oz) + AMS | | |
| Flumi + 2,4-D (SC of Example 2, | 76 | 93 |
| 16 oz) + Credit ® Xtreme (22 oz) + AMS | | |

*COC @ 1% v/v added to all treatments

TABLE 21
Percent Control of Prickly Lettuce

% Control

| Prickly Lettuce | 7 | 14 |
|---|---|---|
| Field Plot Treatments | DAT | DAT |
| Flumi + 2,4-D (SC of Example 2, 16 oz) | 70 | 96 |
| Flumi + 2,4-D (SC of Example 2, 32 oz) | 73 | 90 |
| 2,4-D amine (16 oz) + Flumi (Example 1, 1 oz) | 83 | 100 |
| Tank mix | | |
| 2,4-D amine (32 oz) + Flumi (Example 1, 2 oz) | 80 | 99 |
| Tank mix | | |
| Spitfire ® (20 oz) + COC (dicamba + 2,4-D | 67 | 70 |
| ester) | | |
| Spitfire ® (32 oz) + COC (dicamba + 2,4-D | 73 | 96 |
| ester) | | |
| Flumi (Example 1, 2 oz) + COC | 67 | 90 |
| Credit ® Xtreme (22 oz) + AMS (mixture of | 40 | 88 |
| potassium and isopropyl amine salts | | |
| of glyphosate) | | |
| Spitfire ® (20 oz) + Flumi (Example 1, 1 oz) | 77 | 93 |
| Spitfire ® (20 oz) + Flumi (Example 1, 2 oz) | 83 | 96 |
| Spitfire ® (32 oz) + Flumi (Example 1, 1 oz) | 83 | 96 |
| Spitfire ® (32 oz) + Flumi (Example 1, 2 oz) | 90 | 100 |
| Spitfire ® (20 oz) + Credit ® Xtreme | 63 | 84 |
| (22 oz) + AMS | | |
| Spitfire ® (20 oz) + Flumi (Example 1, | 83 | 96 |
| 1 oz) + Credit ® Xtreme (22 oz) + AMS | | |
| Flumi + 2,4-D (SC of Example 2, | 80 | 99 |
| 16 oz) + Credit ® Xtreme (22 oz) + AMS | | |

*COC @ 1% v/v added to all treatments

TABLE 22
Percent Control of Carolina Geranium

| | % Control |
|---|---|
| Carolina Geranium | 7 |
| Field Plot Treatments | DAT |
| Flumi + 2,4-D (SC of Example 2, 16 oz) | 80 |
| Flumi + 2,4-D (SC of Example 2, 32 oz) | 88 |
| 2,4-D amine (16 oz) + Flumi (Example 1, 1 oz) Tank mix | 83 |
| 2,4-D amine (32 oz) + Flumi (Example 1, 2 oz) Tank mix | 80 |
| Spitfire ® (20 oz) + COC (dicamba + 2,4-D ester) | 70 |
| Spitfire ® (32 oz) + COC (dicamba + 2,4-D ester) | 68 |
| Flumi (Example 1, 2 oz) + COC | 75 |
| Credit ® Xtreme (22 oz) + AMS (mixture of potassium | 50 |
| and isopropyl amine salts of glyphosate) | |
| Spitfire ® (20 oz) + Flumi (Example 1, 1 oz) | 83 |
| Spitfire ® (20 oz) + Flumi (Example 1, 2 oz) | 85 |
| Spitfire ® (32 oz) + Flumi (Example 1, 1 oz) | 80 |
| Spitfire ® (32 oz) + Flumi (Example 1, 2 oz) | 75 |
| Spitfire ® (20 oz) + Credit ® Xtreme (22 oz) + AMS | 65 |
| Spitfire ® (20 oz) + Flumi (Example 1, 1 oz) + Credit ® | 78 |
| Xtreme (22 oz) + AMS | |
| Flumi + 2,4-D (SC of Example 2, 16 oz) + Credit ® | 80 |
| Xtreme (22 oz) + AMS | |

*COC @ 1% v/v added to all treatments

TABLE 23
Percent Control of Wild Radish

| | % Control | | | |
|---|---|---|---|---|
| Wild Radish #1 | 14 | 21 | 28 | 42 |
| Field Plot Treatments | DAT | DAT | DAT | DAT |
| Flumi + 2,4-D (SC of Example 2, 16 oz) | 61 | 95 | 97 | 100 |
| Flumi + 2,4-D (SC of Example 2, 32 oz) | 70 | 96 | 99 | 100 |
| 2,4-D amine (16 oz) + Flumi | 60 | 95 | 93 | 99 |
| (Example 1, 1 oz) Tank mix | | | | |
| 2,4-D amine (32 oz) + Flumi | 71 | 98 | 100 | 100 |
| (Example 1, 2 oz) Tank mix | | | | |
| Spitfire ® (20 oz) + COC | 41 | 31 | 73 | 96 |
| (dicamba + 2,4-D ester) | | | | |
| Spitfire ® (32 oz) + COC | 46 | 33 | 71 | 99 |
| (dicamba + 2,4-D ester) | | | | |
| Flumi (Example 1, 2 oz) + COC | 64 | 66 | 61 | 71 |
| Spitfire ® (20 oz) + Flumi | 72 | 95 | 99 | 100 |
| (Example 1, 1 oz) | | | | |
| Spitfire ® (20 oz) + Flumi | 73 | 97 | 100 | 100 |
| (Example 1, 2 oz) | | | | |
| Roundup PowerMAX ® (glyphosate, | 58 | 92 | 100 | 99 |
| potassium salt, 32 oz) + Valor | | | | |
| (flumioxazin WDG, 2 oz) + 2,4-D | | | | |
| amine (8 oz) | | | | |

*COC @ 1% v/v added to all treatments

TABLE 24
Percent Control of Wild Radish

| | % Control | | | |
|---|---|---|---|---|
| Wild Radish #2 | 9 | 18 | 32 | 38 |
| Field Plot Treatments | DAT | DAT | DAT | DAT |
| Flumi + 2,4-D (SC of Example 2, 16 oz) | 65 | 62 | 90 | 80 |
| Flumi + 2,4-D (SC of Example 2, 32 oz) | 77 | 99 | 100 | 100 |
| 2,4-D amine (16 oz) + Flumi | 68 | 66 | 83 | 85 |
| (Example 1, 1 oz) Tank mix | | | | |
| 2,4-D amine (32 oz) + Flumi | 68 | 88 | 99 | 96 |
| (Example 1, 2 oz) Tank mix | | | | |
| Spitfire ® (20 oz) + COC | 33 | 31 | 65 | 87 |
| (dicamba + 2,4-D ester) | | | | |
| Spitfire ® (32 oz) + COC | 33 | 41 | 70 | 89 |
| (dicamba + 2,4-D ester) | | | | |
| Flumi (Example 1, 2 oz) + COC | 65 | 38 | 28 | 18 |
| Spitfire ® (20 oz) + Flumi | 69 | 88 | 89 | 99 |
| (Example 1, 1 oz) | | | | |
| Spitfire ® (20 oz) + Flumi | 76 | 96 | 96 | 100 |
| (Example 1, 2 oz) | | | | |
| Roundup PowerMAX ® (glyphosate, | 68 | 89 | 90 | 97 |
| potassium salt, 32 oz) + Valor | | | | |
| (flumioxazin WDG, 2 oz) + 2,4-D | | | | |
| amine (8 oz) | | | | |

*COC @ 1% v/v added to all treatments

Table 25 provides data on injury to soybean plants 28 days following treatment of planted field plots. Plots were treated the day after soybean seeds were planted.

TABLE 25
Percent Injury to Soybean

| | % Soybean Injury |
|---|---|
| Field Plot Treatments | 28 DAT |
| Flumi + 2,4-D (SC of Example 2, 16 oz) | 3 |
| Flumi + 2,4-D (SC of Example 2, 32 oz) | 13 |
| 2,4-D amine (16 oz) + Flumi (Example 1, 1 oz) | 0 |
| Tank mix | |
| 2,4-D amine (32 oz) + Flumi (Example 1, 2 oz) | 10 |
| Tank mix | |
| Spitfire ® (20 oz) + COC (dicamba + 2,4-D | 11 |
| ester) | |
| Spitfire ® (32 oz) + COC (dicamba + 2,4-D | 13 |
| ester) | |
| Flumi (Example 1, 2 oz) + COC | 1 |
| Credit ® Xtreme (22 oz) + AMS (mixture of | 1 |
| potassium and isopropyl amine salts of | |
| glyphosate) | |
| Spitfire ® (20 oz) + Flumi (Example 1, 1 oz) | 5 |
| Spitfire ® (20 oz) + Flumi (Example 1, 2 oz) | 13 |
| Spitfire ® (32 oz) + Flumi (Example 1, 1 oz) | 18 |
| Spitfire ® (32 oz) + Flumi (Example 1, 2 oz) | 17 |
| Spitfire ® (20 oz) + Credit ® Xtreme (22 oz) + AMS | 12 |
| Spitfire ® (20 oz) + Flumi (Example 1, 1 oz) + | 12 |
| Credit ® Xtreme (22 oz) + AMS | |
| Flumi + 2,4-D (SC of Example 2, 16 oz) + | 5 |
| Credit ® Xtreme (22 oz) + AMS | |

*COC @ 1% v/v added to all treatments

Table 26 shows percent weed control of 3 weed types. Crop seeds were planted on day 1, the field plots were sprayed with herbicide/herbicide combinations on day 2, and weed control measured on day 13.

TABLE 26
Percent Control of Deadnettle, Chickweed, and Speedwell 13 DAT

| | Deadnettle | Chickweed | Speedwell |
|---|---|---|---|
| Field Plot Treatments | % Control | % Control | % Control |
| Flumi + 2,4-D (SC of Example 2, | 93 | 85 | 77 |
| 16 oz) | | | |
| Flumi + 2,4-D (SC of Example 2, | 100 | 100 | 100 |
| 32 oz) | | | |
| 2,4-D amine (16 oz) + Flumi | 98 | 100 | 97 |
| (Example 1, 1 oz) Tank mix | | | |
| 2,4-D amine (32 oz) + Flumi | 100 | 90 | 97 |
| (Example 1, 2 oz) Tank mix | | | |
| Spitfire ® (20 oz) + COC | 53 | 50 | 40 |
| (dicamba + 2,4-D ester) | | | |
| Spitfire ® (32 oz) + COC | 77 | 77 | 81 |
| (dicamba + 2,4-D ester) | | | |
| Flumi (Example 1, 2 oz) + COC | 93 | 93 | 87 |
| Credit ® Xtreme (22 oz) + AMS | 90 | 100 | 97 |
| (mixture of potassium and | | | |
| isopropyl amine salts | | | |
| of glyphosate) | | | |
| Spitfire ® (20 oz) + Flumi | 97 | 95 | 95 |
| (Example 1, 1 oz) | | | |
| Spitfire ® (20 oz) + Flumi | 99 | 100 | 97 |
| (Example 1, 2 oz) | | | |
| Spitfire ® (32 oz) + Flumi | 98 | 95 | 90 |
| (Example 1, 1 oz) | | | |
| Spitfire ® (32 oz) + Flumi | 95 | 97 | 95 |
| (Example 1, 2 oz) | | | |
| Spitfire ® (20 oz) + Credit ® | 68 | 83 | 82 |
| Xtreme (22 oz) + AMS | | | |
| Spitfire ® (20 oz) + Flumi | 92 | 88 | 80 |
| (Example 1, 1 oz) + | | | |
| Credit ® Xtreme (22 oz) + AMS | | | |
| Flumi + 2,4-D (SC of Example 2, | 97 | 96 | 97 |
| 16 oz) + Credit ® Xtreme | | | |
| (22 oz) + AMS | | | |

*COC @ 1% v/v added to all treatments

TABLE 27
Percent Control of Giant Ragweed

| | % Control | | |
|---|---|---|---|
| Giant Ragweed | 13 | 28 | 55 |
| Field Plot Treatments | DAT | DAT | DAT |
| Flumi + 2,4-D (SC of Example 2, 16 oz) | 75 | 47 | 77 |
| Flumi + 2,4-D (SC of Example 2, 32 oz) | 73 | 63 | 77 |
| 2,4-D amine (16 oz) + Flumi | 67 | 53 | 82 |
| (Example 1, 1 oz) Tank mix | | | |
| 2,4-D amine (32 oz) + Flumi | 78 | 57 | 88 |
| (Example 1, 2 oz) Tank mix | | | |
| Spitfire ® (20 oz) + COC | 73 | 85 | 90 |
| (dicamba + 2,4-D ester) | | | |
| Spitfire ® (32 oz) + COC | 93 | 87 | 92 |
| (dicamba + 2,4-D ester) | | | |
| Flumi (Example 1, 2 oz) + COC | 33 | 17 | 73 |
| Credit ® Xtreme (22 oz) + AMS | 87 | 73 | 87 |
| (mixture of potassium and isopropyl | | | |
| amine salts of glyphosate) | | | |
| Spitfire ® (20 oz) + Flumi | 100 | 95 | 100 |
| (Example 1, 1 oz) | | | |
| Spitfire ® (20 oz) + Flumi | 98 | 83 | 93 |
| (Example 1, 2 oz) | | | |
| Spitfire ® (32 oz) + Flumi | 92 | 73 | 83 |
| (Example 1, 1 oz) | | | |
| Spitfire ® (32 oz) + Flumi | 98 | 83 | 88 |
| (Example 1, 2 oz) | | | |
| Spitfire ® (20 oz) + Credit ® | 97 | 85 | 93 |
| Xtreme (22 oz) + AMS | | | |
| Spitfire ® (20 oz) + Flumi | 88 | 85 | 88 |
| (Example 1, 1 oz) + | | | |
| Credit ® Xtreme (22 oz) + AMS | | | |
| Flumi + 2,4-D (SC of Example 2, | 97 | 67 | 82 |
| 16 oz) + Credit ® Xtreme (22 oz) + AMS | | | |

*COC @ 1% v/v added to all treatments

### Example 6

Field experiments were performed in conventional till or no-till fields to evaluate weed control at various time-points after treatment. The data provide % weed control for treatments with various herbicide combinations on preemergent weeds in newly planted fields.

Preliminary data indicate that treatments 5 and 6 from the table are more effective in controlling weeds than treatment 10, for example.

TABLE 28
Field Plot Treatments

| Trt. # | Treatment | Product/acre | |
|---|---|---|---|
| 1 | Check | — | |
| 2 | Flumioxazin 51% WDG | 2.5 | oz |
| 3 | Pursuit ® herbicide (BASF, imazethapyr, | 4 fl | oz |
| | ammonium salt) | | |
| 4 | Metribuzin 75DF | 7.5 | oz |
| 5 | flumioxazin + imazethapyr + metribuzin | 12 fl | oz |
| | formulation of Example 4 | | |
| 6 | flumioxazin + imazethapyr + metribuzin | 15 fl | oz |
| | formulation of Example 4 | | |
| 7 | Flumioxazin 51% WDG + | 2 oz + | |
| | Pursuit ® herbicide (BASF) | 3.2 fl oz | |
| | Metribuzin 75DF | 6 oz | |
| 8 | Flumioxazin 51% WDG + | 2.5 oz + | |
| | Pursuit ® herbicide (BASF) + | 4 fl oz | |
| | Metribuzin 75DF | 7.5 oz | |
| 9 | Authority ® Assist (FMC, sulfentrazone 33.33% | 8 fl | oz |
| | and imazethapyr 6.67%) | | |
| 10 | Optill ® (BASF, saflufenacil 17.8% and | 1.5 | oz |
| | imazethapyr 50.2% WG with dimethenamid-P | | |
| | 63.9% EC) | | |

1. An aqueous liquid herbicide suspension concentrate composition comprising:
about 40% to about 50% by weight flumioxazin in suspension in a continuous aqueous phase, one or more wetting agents, one or more dispersing agents, one or more antifoam agents, one or more antifreeze agents, and one or more thickening agents.

2. The composition of claim 1, comprising:
about 40% to about 50% by weight flumioxazin,
about 3% to about 5% by weight of one or more wetting agents,
about 1% to about 3% by weight of one or more dispersing agents,
about 0.1% to about 0.2% by weight of one or more antifoam agents,
about 5% to about 7% by weight of one or more antifreeze agents,
about 0.1% to about 0.2% by weight of or more thickening agents, and
about 0.1% to about 0.2% by weight preservative, and
about 30% to about 49% by weight water.

3. The composition of claim 1, comprising:
about 45% by weight flumioxazin,
about 4% by weight of one or more wetting agents,
about 2.3% by weight of one or more dispersing agents,
about 0.1% by weight of or more antifoam agents,
about 6% by weight of one or more antifreeze agents,
about 0.15% by weight of one or more thickening agents,
about 0.1% by weight preservative, and
about 42% by weight water.

4.-19. (canceled)

20. The composition of claim 1, wherein the flumioxazin is milled to a particle size of 1 to 10 micron.

21. The composition of claim 1, wherein the herbicidal component consists essentially of flumioxazin.

22. The composition of claim 1, wherein the composition comprises inert powdered gelling grade attapulgite.

23. The composition of claim 1, wherein the attapulgite is present in an amount to form colloidal gells and provide thixotropic thickening.

24. The composition of claim 23, wherein the attapulgite chemical composition is (Mg,Al)₅Si₈O₂₀.4H₂O.

25. The composition of claim 1, wherein the composition comprises a wetting agent which is a nonionic surfactant.

26. The composition of claim 25, wherein the wetting agent is a nonionic surfactant of HLB of 12.

27. The composition of claim 1, wherein the composition comprises a dispersing agent which is a nonionic surfactant blend.

28. The composition of claim 27, wherein the nonionic surfactant blend has an HLB of 16.

29. The composition of claim 1 wherein the composition comprises a dispersing agent which is sodium salt of naphthalene sulfonate condensate or a blend of alkyl naphthalene sulfonate and anionic wetting agent.

30. The composition of claim 1 wherein the thickening agent comprises a xanthan gum.

31. The composition of claim 1, comprising:
about 40% to about 50% by weight flumioxazin,
about 3% to about 5% by weight of wetting agent which is a nonionic surfactant of HLB 12,
about 1% to about 3% by weight of one or more dispersing agents comprising nonionic surfactant blend of HLB 16 and powdered gelling grade attapulgite.
about 0.1% to about 0.2% by weight antifoam agent,
about 5% to about 7% by weight antifreeze agent,
about 0.1% to about 0.2% by weight thickening agent,
about 0.1% to about 0.2% by weight preservative, and
about 30% to about 49% by weight diluent.

32. The composition of claim 31, wherein the thickening agent is a xanthan gum.

33. A method of controlling the presence of undesirable plants, the method comprising the steps of:
diluting the composition of claim 1 in water; and,
applying an herbicidally effective amount of the diluted composition to the foliage of the undesirable plants or to the soil where undesirable plants grow.

34. An aqueous suspension concentrate composition comprising fumioxazin in an amount of about 5% to about 10% by weight of the composition, metribuzin in an amount of about 30% to about 35% by weight of the composition and imazethapyr in an amount of about 5% to about 10% by weight of the composition, wherein at least the flumioxazin is present in suspension in the aqueous suspension concentrate.

35. The aqueous suspension concentrate composition of claim 34, further comprising one or more wetting agents, one or more dispersing agents, one or more antifoam agents, one or more antifreeze agents, and one or more thickening agents.
